(19) United States
(12) Patent Application Publication
(10) Pub. No.: US 2019/0061152 A1
(43) Pub. Date: Feb. 28, 2019

(54) MEASURING METHOD, PROGRAM, MEASURING APPARATUS AND METHOD OF MANUFACTURING ARTICLE

(71) Applicant: CANON KABUSHIKI KAISHA, Tokyo (JP)

(72) Inventor: Tsuyoshi Kitamura, Utsunomiya-shi (JP)

(21) Appl. No.: 16/101,926

(22) Filed: Aug. 13, 2018

(30) Foreign Application Priority Data
Aug. 30, 2017 (JP) 2017-165323

(51) Int. Cl. B25J 9/16; G06T 7/73; G01B 11/02; G06F 17/50

(52) U.S. Cl. CPC B25J 9/1612; B25J 9/1697; G06F 17/50; G01B 11/02; G06T 7/73

(57) ABSTRACT

According to an aspect of the invention, a measuring method measures a position and a posture of an object. The method comprises: a first calculation step of processing a first image obtained by imaging the object as a first processing object; and a second calculation step of determining a position and a posture of the object by processing a plurality of constituent elements in the image as a second processing object on the basis of the result of the first calculation step. The second processing object is associated with the first processing object.

### BACKGROUND OF THE INVENTION

### Field of the Invention

The present invention relates to a measuring method, a program, a measuring apparatus, and a method of manufacturing an article.

### Description of the Related Art

Robots having gripping parts configured to grip objects are now performing complex tasks (such as the assembly of industrial products) which have been done by humans. Gripping parts are controlled on the basis of the measurement results of measuring apparatuses configured to measure the arrangement of objects (for example, positions and postures).

Sizes or materials of objects handled by robots are various. Generally, there is a distribution of machining accuracy in each of a plurality of constituent elements constituting an object. In addition, there is a case in which a position or a posture of an object is not determined before and after a gripping part grips the object or a case in which the entire object does not fit into an image used by a measuring apparatus in some cases.

There is a measuring apparatus which acquires the disposition of an object with high accuracy by a two-stage measurement method of roughly acquiring the disposition thereof by processing an image of an object and accurately acquiring the disposition thereof by further processing the image on the basis of the acquired disposition. For example, Japanese Patent Laid-Open No. 2011-22991 includes detection of a specimen and calculation of a rough position and posture by performing voting using a pre-learned classification tree for an acquired image. Japanese Patent Laid-Open No. 2011-27623 includes calculation of a position and posture of a workpiece with high accuracy by correcting the position and posture so that a three-dimensional shape model of the workpiece and an acquired image fit. There is an apparatus which acquires the disposition of an object with high accuracy by performing the calculation in Japanese Patent Laid-Open No. 2011-22991 and performing the calculation in Japanese Patent Laid-Open No. 2011-27623 on the result.

In a measuring apparatus for performing two-stage image processing, it is important to combine an object portion in an image processed at the time of roughly acquiring the disposition and an object portion used at the time of accurately acquiring the disposition. For example, when most of the object portion in the image processed at the time of roughly acquiring the disposition is photographed in the image, it is assumed that an approximate disposition has been calculated. However, when the object portion used at the time of accurately acquiring the disposition is far away from the object portion in the image processed at the time of roughly acquiring the disposition and the object portion used at the time of accurately acquiring the disposition is not photographed in the image, the disposition cannot be estimated with high accuracy.

In existing image processing apparatuses including the image processing apparatus of Japanese Patent Laid-Open No. 2015-199155, separate region images and processing means are in one-to-one correspondence. Therefore, even when the image processing apparatus of Japanese Patent Laid-Open No. 2011-22991 is used in a measuring apparatus, a combination of a part which is subjected to rough processing and a part which is subjected to accurate processing cannot be flexibly set. Considering the situation described above, the fact that only a part used at the time of acquiring one accurate disposition is registered for a part used at the time of acquiring one rough disposition leads to inconvenience.

### SUMMARY OF THE INVENTION

The present invention proposes a measuring apparatus which is advantageous in terms of measurement accuracy.

According to an aspect of the invention, a measuring method measures a position and a posture of an object. The method comprises: a first calculation step of processing a first image obtained by imaging the object as a first processing object; and a second calculation step of determining a position and a posture of the object by processing a plurality of constituent elements in the image as a second processing object on the basis of the result of the first calculation step. The second processing object is associated with the first processing object.

Further features of the present invention will become apparent from the following description of exemplary embodiments with reference to the attached drawings.

### BRIEF DESCRIPTION OF THE DRAWINGS

FIG. 1 is a block diagram schematically illustrating an example of an overall configuration of a measuring apparatus using a measuring method according to a first embodiment and showing a main configuration of a processing unit.

FIG. 2 is a diagram illustrating an example of an object serving as an object to be inspected.

FIG. 3 is a flowchart for describing the measuring method according to the first embodiment.

FIGS. 4A to 4C are diagrams for explaining images stored in an image storage unit.

FIG. 5 is a diagram illustrating an example of a first processing object.

FIG. 6 is a diagram illustrating an example of a relationship between the first processing object and a second processing object.

FIG. 7 is a flowchart for describing determination of a position and posture in detail.

FIG. 8 is a diagram illustrating an example of the first processing object.

FIG. 9 is a diagram illustrating an example of a relationship between the first processing object and the second processing object.

FIG. 10 is a block diagram schematically illustrating an example of an overall configuration of a measuring apparatus using a measuring method according to a third embodiment and showing a main configuration of a processing unit.

FIG. 11 is a diagram illustrating a first example of a method of displaying information by a display unit.

FIG. 12 is a diagram illustrating a second example of a method of displaying information by a display unit.

FIG. 13 is a diagram illustrating a third example of the method of displaying information by the display unit.

FIG. 14 is a diagram illustrating a fourth example of the method of displaying information by the display unit.

FIG. 15 is a diagram illustrating a fifth example of the method of displaying information by the display unit.

FIG. 16 is a diagram showing a control system including a gripping apparatus having a measuring apparatus included therein.

### DESCRIPTION OF THE EMBODIMENTS

Embodiments of the present invention will be described below with reference to the drawings or the like.

### First Embodiment

(Measuring Apparatus)

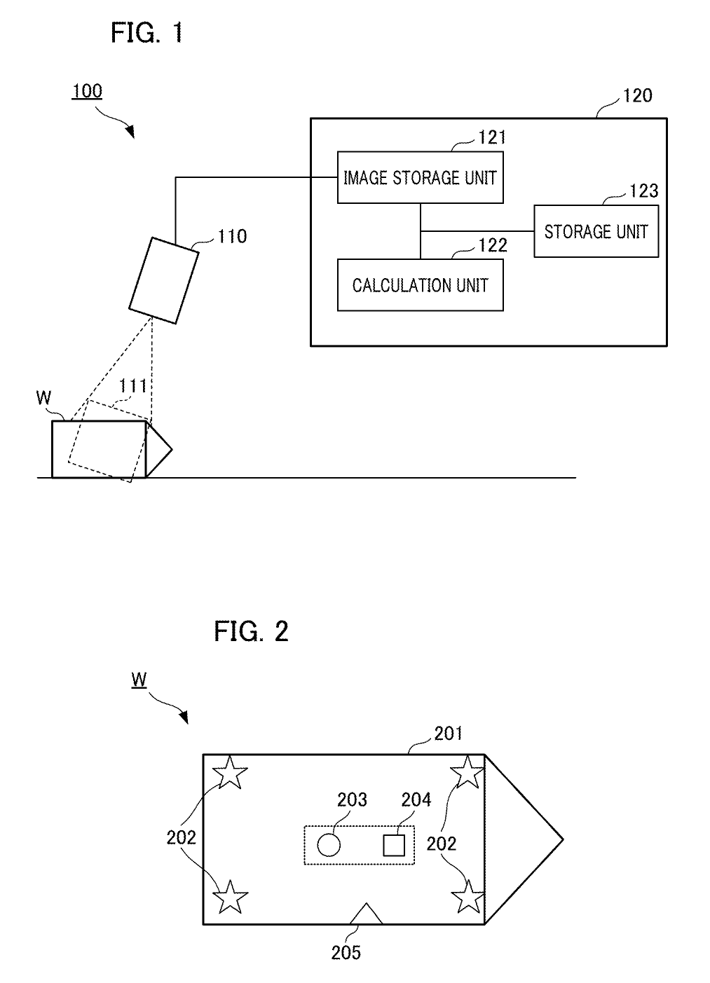

FIG. 1 is a block diagram schematically illustrating an example of an overall configuration of a measuring apparatus 100 using a measuring method according to a first embodiment and showing a main configuration of a processing unit 120. The measuring apparatus 100 includes an image acquisition unit 110 and the processing unit 120.

The image acquisition unit 110 captures an image of an object W serving as an object to be inspected. The image captured by the image acquisition unit 110 is sent to an image storage unit 121 provided inside the processing unit 120. The image acquisition unit 110 includes, for example, a projection unit (not shown) and an imaging unit (not shown). The projection unit projects pattern light onto the object W. It should be noted that the projection unit may project pattern light onto a part of the object W or may project uniform light onto the object W instead of pattern light. When pattern light is projected, the projection unit includes a pattern generation unit (not shown) and a projection optical system (not shown).

The pattern generation unit generates pattern light projected using the projection optical system. Examples of pattern light include a periodic line pattern (stripe pattern) in which bright portions formed by bright lines and dark portions formed by dark lines are alternately arranged. The imaging unit images an object onto which light is projected.

The imaging unit images the object W within a field of view range 111 in which light is projected. The imaging unit includes an imaging optical system (not shown) and an imaging element (not shown). The imaging unit acquires an image by receiving light reflected from the object using the imaging element via the imaging optical system. The imaging element may use an optical sensor such as a complementary metal-oxide semiconductor (CMOS) or a charge coupled device (CCD). The imaging element may be an imaging element with a color filter or a monochrome imaging element.

The processing unit 120 realizes processing of a main algorithm of the measuring apparatus 100 according to this embodiment using a computer and an electrical circuit. The processing unit 120 performs a process of acquiring an accurate position and posture (inclination or aspect) of the object W from an image captured by the imaging unit. The processing unit 120 includes the image storage unit 121, a calculation unit 122, and a storage unit 123.

The image storage unit 121 stores an image of the object W captured by the image acquisition unit 110. The storage unit 123 stores settings information concerning calculation which will be described later. A program causing a computer to execute the measuring method according to the embodiment may be stored in the storage unit 123. The calculation unit 122 acquires a position and a posture of the object W using the settings information stored in the storage unit 123 with respect to the image stored in the image storage unit 121.

In the embodiment, the calculation unit 122 processes an image using calculations of two types including a first calculation and a second calculation to acquire the position and the posture of the object W. In the embodiment, the first calculation includes estimating an approximate position and posture of the object W The second calculation includes acquiring a specific position and posture of the object W using the result (processing result) of the first calculation. In addition to this, calculations of two types in which calculation times are different may be performed in the first calculation and the second calculation.

The first calculation is estimated, for example, by matching learning information which will be described later and three-dimensional information acquired from an image acquired by the imaging unit. The second calculation is performed by matching model information of the object W or constituent elements (components, structure members) of the object W and three-dimensional information acquired from the image acquired by the imaging unit. The model information will be described in detail later. An initial position of the object W at the time of performing matching in the second calculation uses an approximate position and posture result in the first calculation.

FIG. 2 is a diagram illustrating an example of an object serving as an object to be inspected. The object W includes a housing 201 and a plurality of constituent elements 202 to 205. The housing 201 is prepared by molding a resin. The plurality of constituent elements 202 to 205 are formed on a surface of the housing 201. The constituent element 202 is indicated by an asterisk, the constituent element 203 is indicated by a circle, the constituent element 204 is indicated by a quadrangle, and the constituent element 205 is indicated by a triangle. The measuring method according to the embodiment includes measuring the object W using the plurality of constituent elements 202 to 205. Details thereof will be described later.

In the embodiment, manufacturing accuracies acceptable for the plurality of constituent elements 202 to 205 are different. For example, when the object W is connected to another object, if the constituent elements 203 and 204 are set as constituent elements serving as connecting portions, manufacturing accuracies for the constituent elements 203 and 204 are higher than those of the constituent elements 202 and 205.

In the measuring method according to the embodiment, an approximate position and posture of the object W is estimated on the basis of a first portion (first processing object) constituting the object W in an image acquired by the image acquisition unit 110. Moreover, the object in an image is matched with the model information on the basis of a plurality of second processing objects associated with the estimation results and a first processing object. The matching results obtained for the plurality of second processing objects are compared and a specific position and posture of the object W is determined. At the time of matching with the model information, contour information included in the second processing object, distance information of the housing 201, or the like is used. Here, both of the first and second processing objects may be interpreted as a part of the object W (relative characteristic part) or as a part of an image obtained by photographing the object W (corresponding to a part of the image).

(Measuring Method)

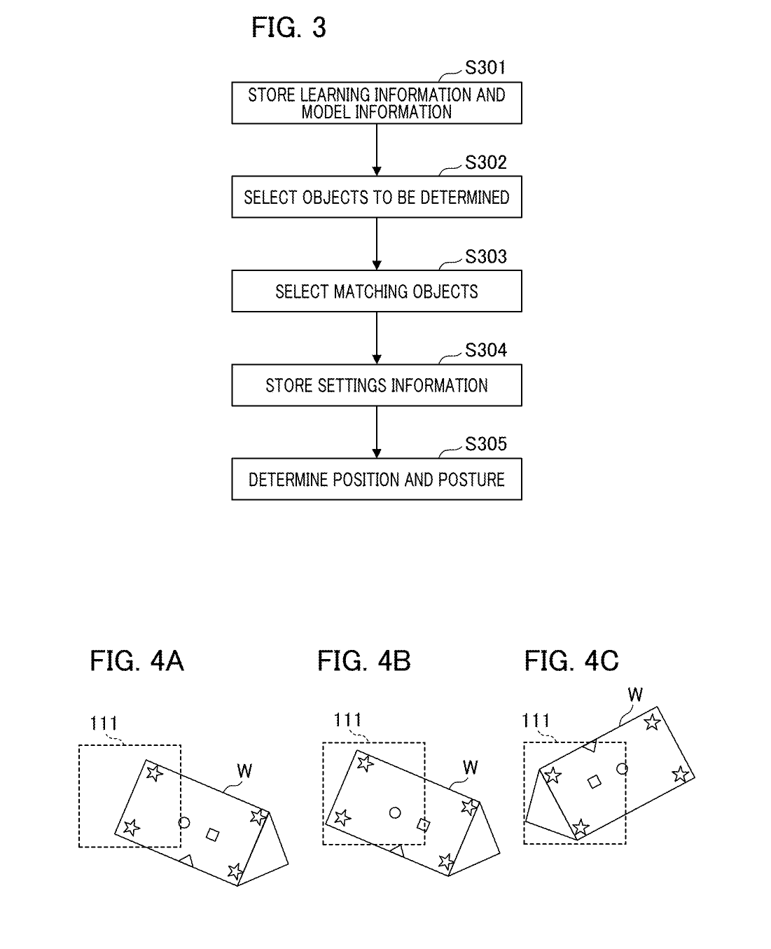

FIG. 3 is a flowchart for describing the measuring method according to the first embodiment. Each flow is mainly performed by each part in the processing unit 120. Step S301 and Steps S302 to S304 are in an arbitrary order. That is to say, it is only necessary that the processes are performed before the calculation of a position and posture in Step S305.

First, in Step S301, the storage unit 123 stores learning information and model information. The learning information is information obtained by processing a plurality of images obtained by photographing the object W in a plurality of directions (imaging angles) in advance. The model information is created, for example, using a previously created computer aided design (CAD) model of the object W.

(Learning Information Used in First Calculation)

FIGS. 4A to 4C are diagrams for explaining images stored in the image storage unit 121. In the stored images, it is assumed that the object W is photographed in various ways. In the embodiment, it is assumed that the object W has a size of about twice that of the field of view range 111 in the imaging unit and that the position and the posture of the object W is highly unstable.

FIGS. 4A to 4C illustrate an example of a relative relationship between the field of view range 111 and the object W. Actually, a relative relationship between a field of view range and a size of the object W also changes in accordance with the size of the object W, a specification of the measuring apparatus 100, or an imaging height. Ambiguity in a posture of the object W may exist like in an example illustrated in FIGS. 4A to 4C. In addition to this, ambiguity in a direction perpendicular to a ground surface may exist in some cases. Thus, a very large number of patterns are assumed for a portion of the object W photographed in an image.

As illustrated in FIGS. 4A to 4C, the object W in the embodiment is larger than a field of view range and thus the entire object W does not fall within the field of view range. The entire object W has not been captured in the images stored in the image storage unit 121 and half of the object W at a maximum has been captured. Therefore, in the first calculation, it is desirable to use learning information obtained from a portion close to a portion which is not the entire object W and captured in any of the images.

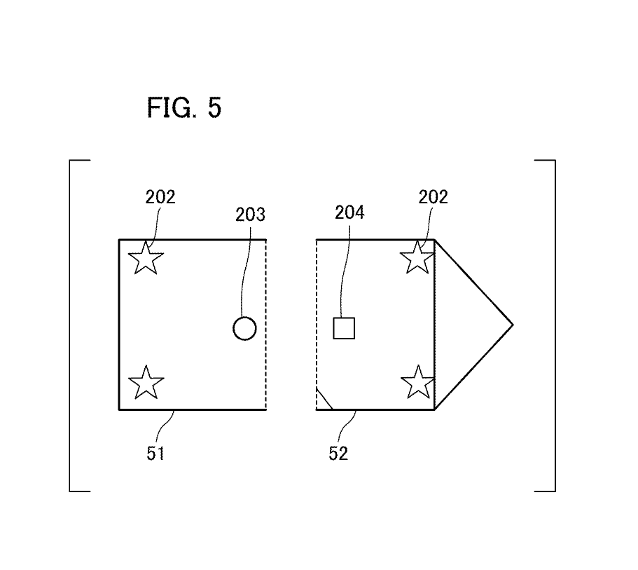

Referring back to FIG. 3, in Step S302, a user selects (determines) first processing objects to be subjected to the first calculation. FIG. 5 is a diagram illustrating an example of the first processing object (object to be determined). In the embodiment, a first portion 51 and a second portion 52 different from the first portion 51 are set as the first processing objects. The selected portions are stored in the storage unit 123. It is assumed that any of the selected portions is expected to have a large portion photographed in a field of view when the object W is measured.

In Step S303, the user selects a second processing object. The second processing object may or may not include any constituent element including any of the first processing objects. In the embodiment, the second processing object includes a constituent element included in the first processing object associated with the second processing object. In the second calculation, it is required to perform measurement with higher accuracy than in the first calculation. As described above, the second calculation is performed by matching the model information of the object W and contour information or three-dimensional information obtained from an image acquired by the image acquisition unit 110. However, when manufacturing accuracies of constituent elements constituting the object W are low, deviation from the model information increases and thus accuracy of the second calculation deteriorates.

Thus, it is desirable that the second calculation be performed on a constituent element of the object W having a high manufacturing accuracy. In the embodiment, as described above, manufacturing accuracies of the constituent elements 203 and 204 are higher than those of other constituent elements. Therefore, the second calculation is preferably performed on the constituent element 203 or 204. Here, since there is also a case in which the constituent elements 203 and 204 are not included in an image in some cases, another constituent element may be selected as an object used in the second calculation. The selected constituent element is stored in the storage unit 123.

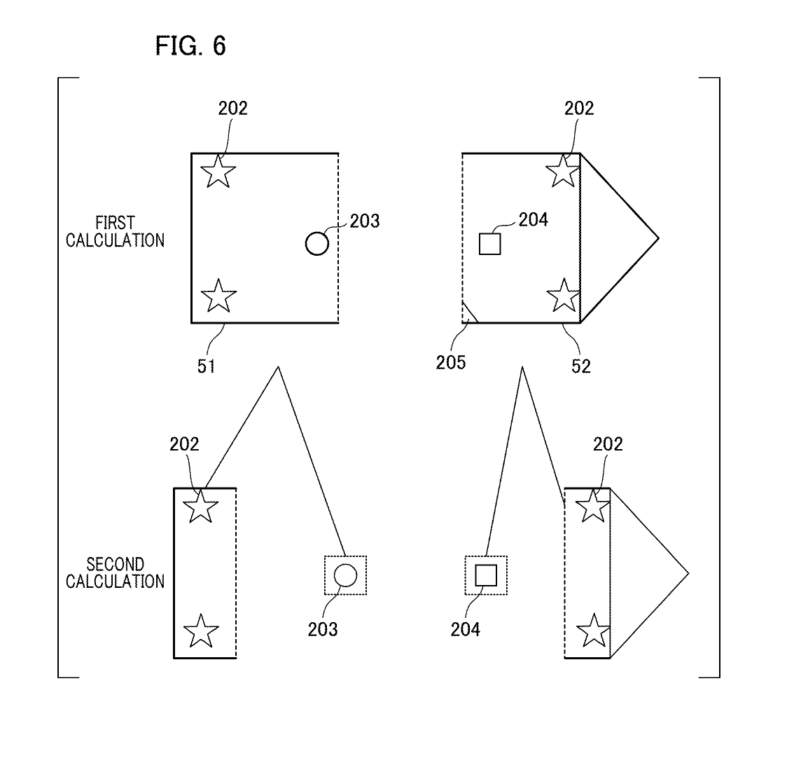

An example of a relationship between the first processing object stored in Step S302 and the second processing object stored in Step S303 is illustrated in FIG. 6. The first processing object used in the first calculation and the second processing object used in the second calculation are set to one set and four sets of calculation set are stored in the storage unit 123. That is to say, two sets in which the first calculation is performed using the first portion 51 and the second calculation is performed using the second processing object including the constituent element 202 or 203 may be provided. Furthermore, two sets in which the first calculation is performed using the second portion 52 and the second calculation is performed using the second processing object including the constituent element 202 or 204 may be provided. Each set is stored as settings information in Step S304. After Step S304, calculation of a position and posture is performed in Step S305.

(Calculation of Position and Posture)

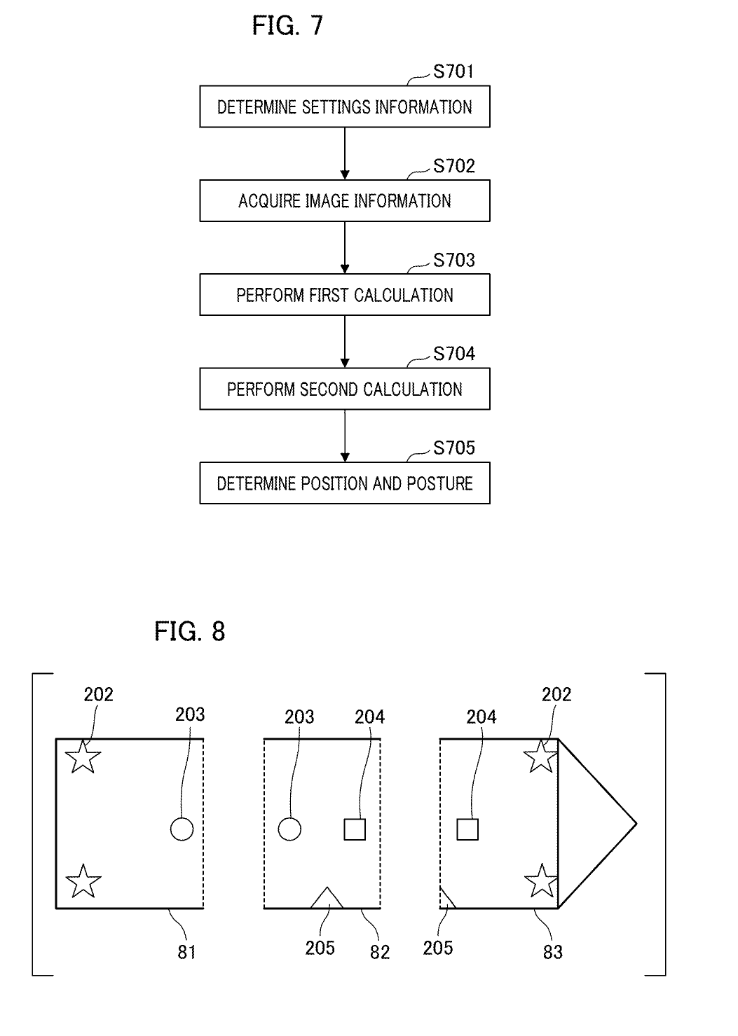

FIG. 7 is a flowchart for describing Step S305 illustrated in FIG. 3 in detail. First, in Step S701, the user selects a calculation set used for measurement from the storage unit 123. Here, the selection is determined on the basis of a manner of viewing the object W in an image assumed during actual measurement. In the embodiment, it is assumed that four sets of calculation set illustrated in FIG. 6 are selected. In Step S702, the image acquisition unit 110 acquires an image of the object W and stores the image in the image storage unit 121.

The calculation unit 122 performs the first calculation in Step S703 on the basis of the settings information acquired in Step S701 and then performs the second calculation in Step S704. It should be noted that a step of determining whether to use any of the calculation sets selected in Step S701 in Step 5704 may be provided between Step S703 and Step S704. That is to say, a portion used in the second calculation in Step S704 may be selected on the basis of the result of the first calculation in Step S703 so that the second calculation in Step S704 is performed using the selected portion. For example, if it is determined from the result of the first calculation in Step S703 that an estimation accuracy of a position and a posture in a case in which the first portion 51 is used is higher than that of a case in which the second portion 52 is used, the second calculation may be performed using the constituent elements 202 and 203 of the second processing object associated with the first portion 51.

In Step S705, the calculation unit 122 determines a position and a posture of the object W on the basis of scores (results of matching) indicating matching (degree of matching, concordance rate) of an image with the model information calculated by the second calculation. According to the settings in the embodiment, since the second calculation is performed using the constituent element 202 or 203, the number of results of matching is two. The calculation unit 122 uses a result of greater matching between the two results of matching to determine a position and posture.

According to the measuring apparatus 100 in the embodiment, a combination of a portion to be subjected to the first calculation and a portion to be subjected to the second calculation can be flexibly set. Therefore, the measuring apparatus 100 is advantageous, for example, in terms of measurement availability and measurement accuracy regardless of an imaged portion of the object W. Furthermore, the measuring apparatus 100 can also be advantageous in terms of a calculation time and the number of processes.

### Second Embodiment

In the first embodiment, no duplication of constituent elements is assumed among a plurality of portions which can be used in the first calculation. However, common constituent elements can also be provided among the plurality of portions which can be used in the first calculation in some cases.

For example, a case in which the first processing object as the object W illustrated in FIG. 2 is designated by three types, i.e., a first portion 81, a second portion 82, and a third portion 83 like in FIG. 8 may be considered. As illustrated in FIG. 8, the first portion 81 includes constituent elements 202 and 203 and the second portion 82 includes a common constituent element 203 with respect to the first portion 81 and constituent elements 204 and 205. The third portion 83 also includes common constituent elements.

This embodiment is characterized by each first processing object including a common second processing object. It should be noted that an apparatus configuration and a measurement flow are the same as in the first embodiment.

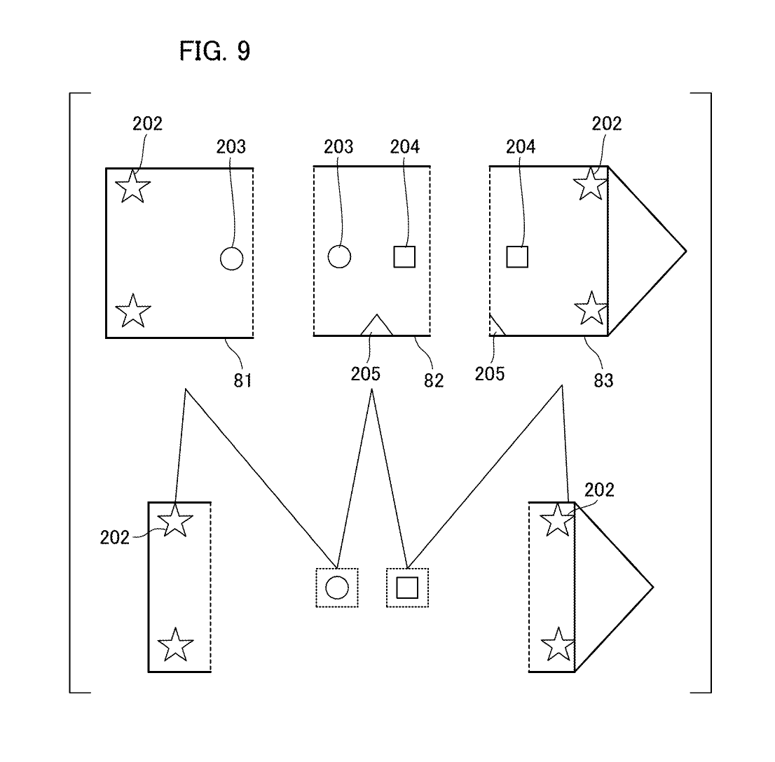

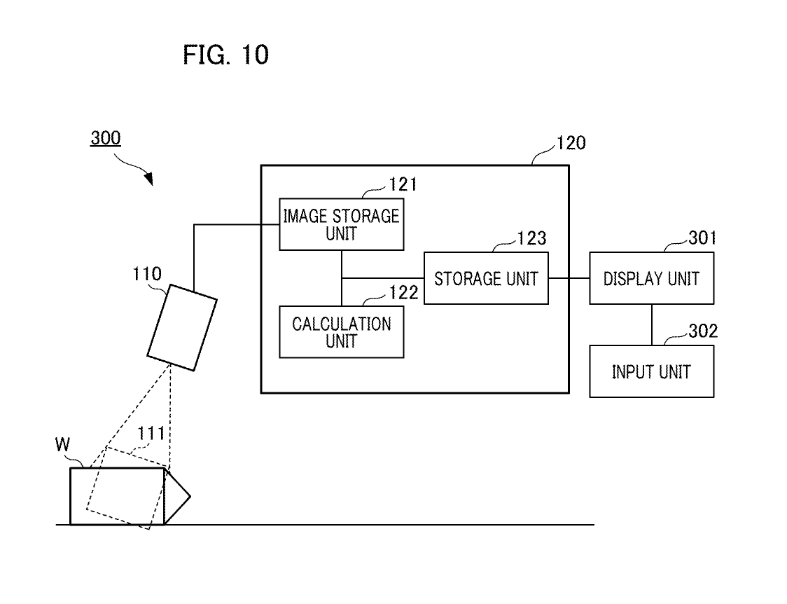

FIG. 9 is a diagram illustrating an example of a relationship between a first processing object and a second processing object. A first processing object used in a first calculation and a second processing object used in a second calculation are set to one set and six sets of calculation set are stored in a storage unit 123. That is to say, first, two sets in which the first calculation is performed using the first portion 81 and the second calculation is performed using the second processing object including the constituent element 202 or 203 may be provided. Furthermore, two sets in which the first calculation is performed using the second portion 82 and the second calculation is performed using the second processing object including the constituent element 203 or 204 may be provided. In addition, two sets in which the first calculation is performed using the third portion 83 and the second calculation is performed using the second processing object including the constituent element 202 or 204 may be provided. The same effects as in the first embodiment can also be obtained by this embodiment.

### Third Embodiment

A measuring method according to a third embodiment has features concerning a method of storing settings information. This embodiment is characterized by a first processing object and a second processing object being designated at different timings in a stepwise manner when settings information is stored in a storage unit 123.

FIG. 10 is a block diagram schematically illustrating an example of an overall configuration of a measuring apparatus 300 using the measuring method according to the third embodiment and showing a main configuration of a processing unit 120. Constituent elements that are the same as those of the first embodiment will be denoted with the same reference numerals and description thereof will be omitted. The measuring apparatus 300 according to this embodiment includes a display unit 301 and an input unit 302.

The display unit 301 is connected to the processing unit 120. The input unit 302 is connected to the display unit 301. For example, the display unit 301 displays required information when storing settings information in the storage unit 123. The user gives instructions to the display information by the input unit 302. The display unit 301 stores settings information in the storage unit 123 on the basis of an output from the input unit 302.

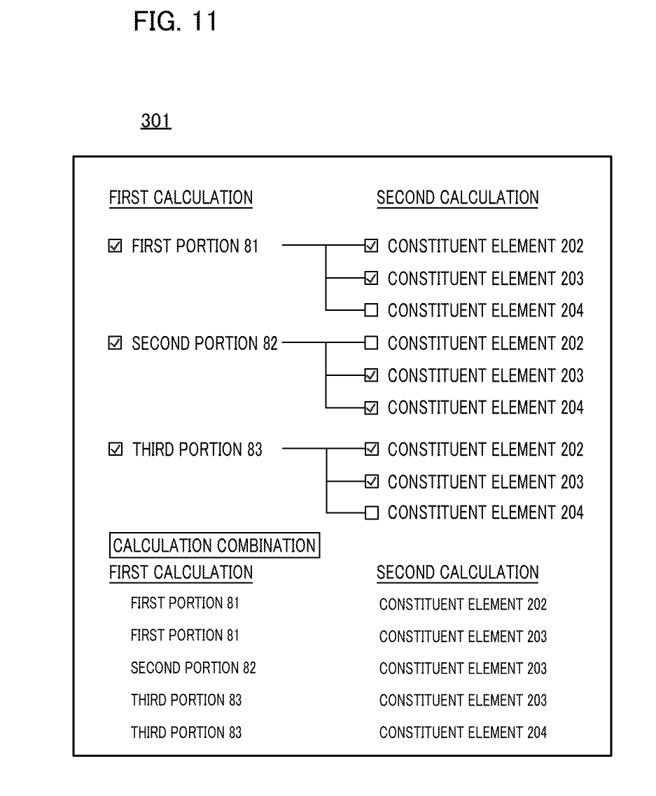

FIG. 11 is a diagram illustrating a first example of a method of displaying information by a display unit 301. This example illustrates the settings information illustrated in FIG. 9. As illustrated in FIG. 11, a first processing object to be designated is selected by selecting a checkbox. Moreover, a second processing object associated with the first processing object is selected by selecting a checkbox.

In an upper part of the display unit 301, as illustrated in FIG. 9, two sets in which the first calculation is performed using a first portion 81 and the second calculation is performed using the second processing object including constituent element 202 or 203 are selected by selecting a checkbox corresponding to FIG. 11. In a lower part of the display unit 301, a combination of portions used in two calculations is displayed in accordance with a combination of checks. Thus, the user can check that desired setting has been provided.

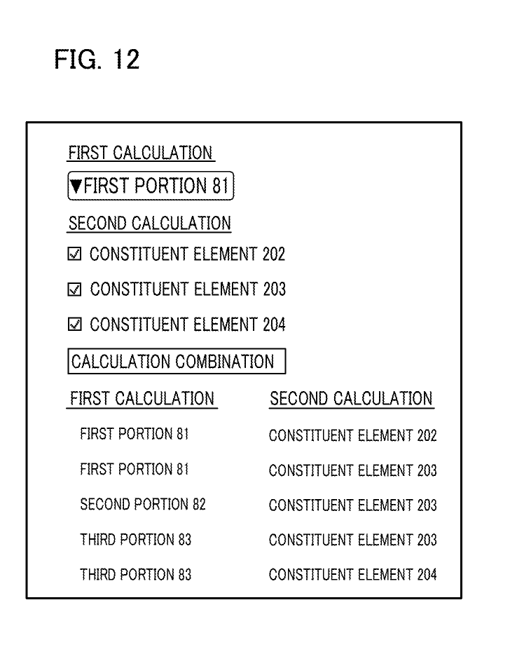

FIG. 12 is a diagram illustrating a second example of the method of displaying information by a display unit 301. As illustrated in FIG. 12, the first processing object may be designated in a pull-down manner so that the second processing object is displayed in a list for a portion selected in this way and selected using a checkbox. Since a region in which a selection result of the first processing object is displayed, a region in which a selection result of the second processing object is displayed, and a region in which a combination thereof is displayed are displayed on the same screen of the display unit 301 of FIG. 12, a display space is reduced.

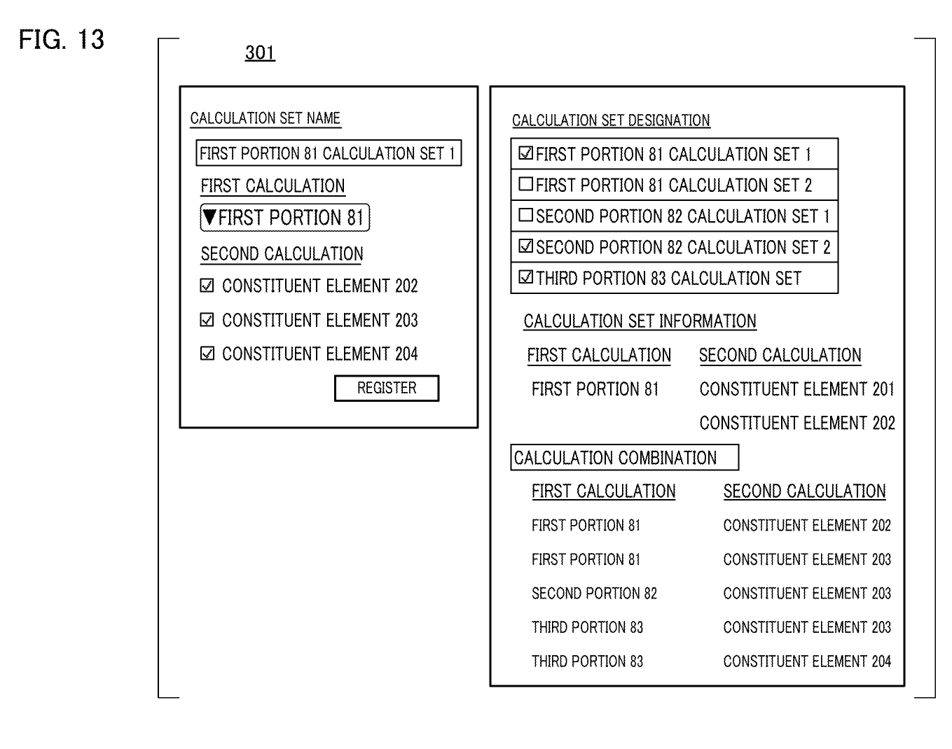

FIG. 13 is a diagram illustrating a third example of the method of displaying information by a display unit 301. As illustrated in FIG. 13, one calculation set is registered in any window. When a combination of this calculation set and a calculation set which has been registered in another window is set, the combination in which the two calculations are performed is registered.

A window illustrated on the left of FIG. 13 is a window configured to register a calculation set and a calculation set is registered by selecting one object to be estimated in a pull-down manner, selecting a checkbox for a matching object, and pressing a registration button. The registered calculation set is displayed in a list in a window illustrated on the right of FIG. 13. When one calculation set is selected in the list, details of the calculation set are illustrated in a calculation set information column.

Also, all combinations of a set designated by selecting a checkbox in the list are displayed in a calculation combination column. The set designated by selecting the checkbox is set to be a calculation set actually used in calculation and thus a combination for performing calculations (settings information) is stored.

When the display unit 301 in FIG. 13 is used, if a combination of a portion used in the first calculation and a portion used in the second calculation is set in advance before determination of settings information, a setting operation is completed simply by selecting the portion used in the first calculation when the settings information is determined. That is to say, once a calculation set is registered, the calculation set can be designated without performing setting for the calculation set again when the same object to be inspected is measured in different situations.

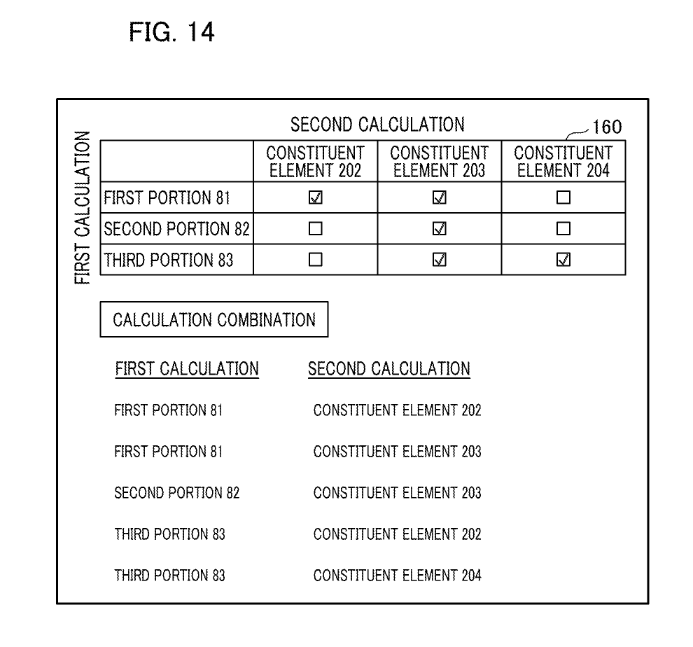

FIG. 14 is a diagram illustrating a fourth example of the method of displaying information by a display unit 301. The display unit 301 illustrated in FIG. 14 displays first processing objects and second processing objects which can be selected in a matrix. According to this display method, a combination of settings information can be determined by a single operation (one operation).

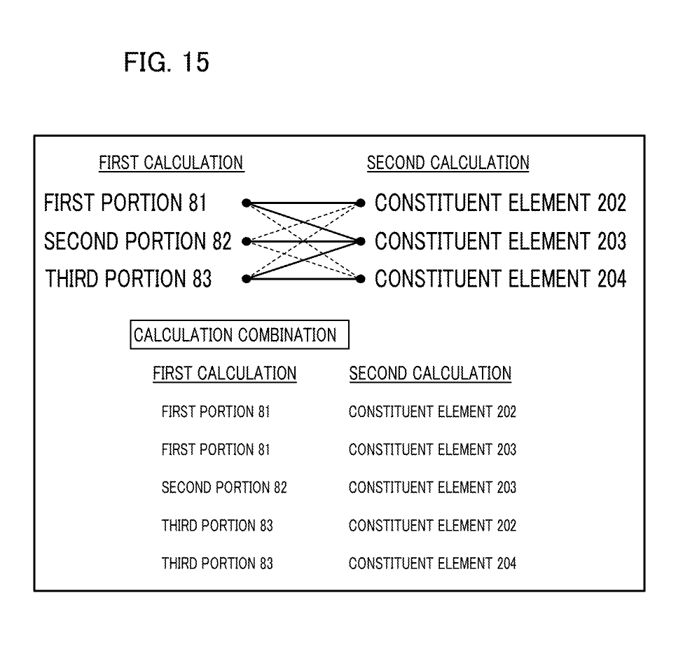

FIG. 15 is a diagram illustrating a fifth example of the method of displaying information by a display unit 301. The display unit 301 illustrated in FIG. 15 displays first processing objects and second processing objects which can be selected in two rows. A combination of settings information which is selected is indicated by a solid line and a combination of settings information which is not selected is indicated by a dotted line. According to this display method, a combination of settings information can be determined on one screen.

Also, for example, portions of the object W which a first processing object and a second processing object indicate may be displayed on the display unit 301 by CAD data and additional information such as the number of calculations performed in accordance with set conditions may be indicated. Thus, convenience when the user performs setting is improved.

Also, second processing objects associated with the first processing object may be sorted to some extent before the above-described screen is displayed, the sorted second processing objects may be displayed when a first processing object has been selected, and any among them may be registered. In the example of FIG. 9, when the first calculation is performed using the first portion 81, since the second calculation is not performed using the second processing object including the constituent element 204, the second processing object including the constituent element 204 is set as an excluded constituent element in advance. In this case, for example, when the first portion 81 is selected in the display unit 301 illustrated in FIG. 12, only the second processing object including the constituent elements 202 and 203 is displayed. Alternatively, a checkbox of the second processing object including the constituent element 204 cannot be selected. Thus, since clearly unnecessary combinations are not displayed, erroneously setting clearly unnecessary combinations can be prevented.

It should be noted that an input of information indicated on the display unit 301 may be designated by an electronic message of a command or the like.

(Embodiment Related to Method of Manufacturing Article)

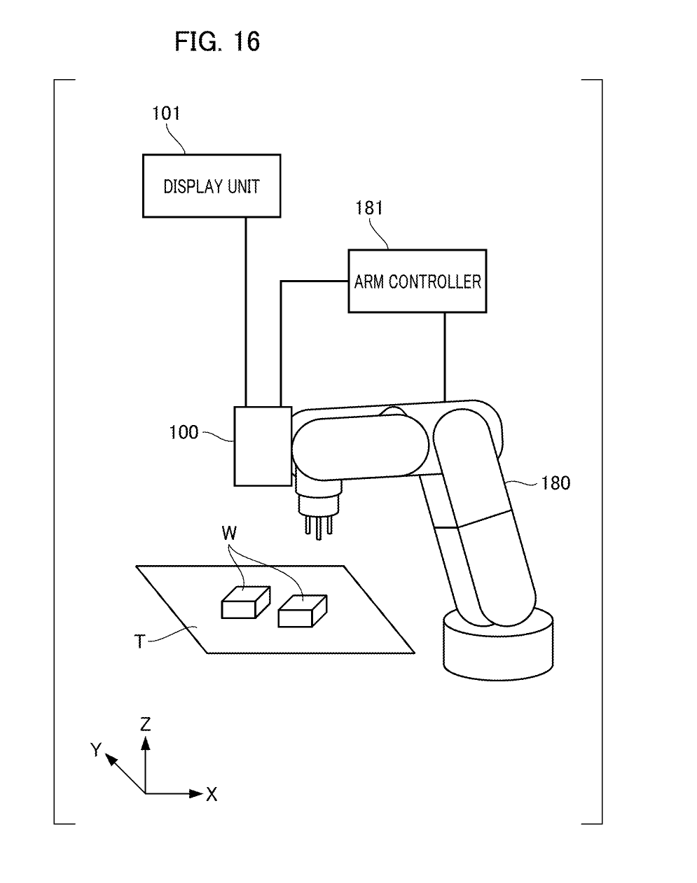

The above-described measuring apparatus can be used while being supported by a certain support member. In this embodiment, for example, a control system provided and used in a robot arm 180 (gripping apparatus) like in FIG. 16 will be described. A measuring apparatus 100 projects pattern light onto an object W placed on a support base T, captures an image of the object W, and acquires the image. Moreover, a controller (not shown) of the measuring apparatus 100 or an arm controller 181 which has acquired image data output from the controller (not shown) of the measuring apparatus 100 acquires a position and a posture of an object and the arm controller 181 acquires information on the acquired position and posture. The arm controller 181 sends a drive command to the robot arm 180 on the basis of the information on the position and the posture (measurement results) and controls the robot aim 180. The robot arm 180 holds the object W by a robot hand or the like (gripping part) at a distal end thereof and causes the object W to perform movement such as translation or rotation. In addition, when the object W is attached to (assembled with) another part by the robot arm 180, an article constituted of a plurality of parts, for example, an electronic circuit board, a machine, or the like can be manufactured. Furthermore, when the moved object W is machined (processed), an article can be manufactured. The arm controller 181 includes a computing device such as a central processing unit (CPU) and a storage device such as a memory. It should be noted that a controller configured to control a robot may be provided outside of the arm controller 181. Furthermore, measurement data from measurement by a measuring apparatus 100 and an obtained image may be displayed on a display unit 101 such as a display.

Note that, although calculations having different degrees of refinement are used as a plurality of calculation methods used for estimating a position and posture in the embodiment, the calculations may be calculations with different calculation speeds. Furthermore, in the second calculation, different constituent elements (for example, constituent elements 203 and 204) may be selected as one set.

### Other Embodiments

Although the embodiments of the present invention have been described above, the present invention is not limited to these embodiments and various modifications are possible without departing from the gist of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2017-165323 filed on Aug. 30, 2017, which are hereby incorporated by reference herein in its entirety.

What is claimed is:

1. A measuring method that measures a position and a posture of an object, the method comprising:
a first calculation step of processing a first image obtained by imaging the object as a first processing object; and
a second calculation step of determining a position and a posture of the object by processing a plurality of constituent elements in the image as a second processing object on the basis of the result of the first calculation step,
wherein the second processing object is associated with the first processing object.

2. The measuring method according to claim 1, wherein, in the first calculation step, a first image and a second image obtained by imaging the object as the first processing object are processed, and
both of the first image and the second image include the plurality of constituent elements.

3. The measuring method according to claim 2, wherein the second calculation step is performed on the plurality of constituent elements photographed in one of the first image and the second image.

4. The measuring method according to claim 1, wherein the first calculation step is a step of estimating the position and the posture of the object by matching the first image with previously acquired learning information.

5. The measuring method according to claim 4, wherein the learning information includes a plurality of images obtained by imaging the object at a plurality of imaging angles.

6. The measuring method according to claim 4, wherein the second calculation step is a step of determining the position and the posture of the object by matching the plurality of constituent elements with previously created model information.

7. The measuring method according to claim 6, wherein the model information includes a computer aided design (CAD) model of the object.

8. The measuring method according to claim 1, wherein the plurality of constituent elements are constituent elements from which a highest accuracy is obtained in the second calculation step among all constituent elements included in the first image.

9. The measuring method according to claim 1, further comprising:
a storage step of storing a relationship between a plurality of portions of the object and constituent elements in which the second calculation step is effectively able to be performed on each of the plurality of portions.

10. The measuring method according to claim 9, wherein the first image is an image obtained by imaging one of the plurality of portions, and
the first processing object and the second processing object are determined on the basis of the relationship before the first calculation step.

11. The measuring method according to claim 10, wherein the second processing object is determined after the first processing object is determined.

12. The measuring method according to claim 10, wherein the second processing object is associated with the first processing object in advance on the basis of the relationship and
the second processing object is selected by selecting the first processing object.

13. A non-transitory storage medium on which a computer program for making a computer execute a measuring method that measures a position and a posture of an object is stored, the method comprising:
a first calculation step of processing a first image obtained by imaging an object as a first processing object; and
a second calculation step of determining a position and a posture of the object by processing a plurality of constituent elements in the first image as a second processing object on the basis of the result of the first calculation step,
wherein the second processing object is associated with the first processing object.

14. A measuring apparatus that measures a position and a posture of the object, the apparatus comprising:
a memory; and
a processing unit that operates on the basis of a program stored in the memory,
wherein the processing unit comprises:
a first calculation unit that processes a first image obtained by imaging the object as a first processing object; and
a second calculation unit that determines a position and a posture of the object by processing a plurality of constituent elements in the first image as a second processing object on the basis of a calculation result of the first calculation unit,
wherein the second processing object is associated with the first processing object.

15. The measuring apparatus according to claim 14, wherein the processing unit further includes a display unit that simultaneously displays a first region, a second region, and a third region,
the first region includes a selection result of the first processing object displayed therein,
the second region includes a selection result of the second processing object displayed therein, and
the third region includes a combination of the first processing object and the second processing object displayed therein.

16. A system comprising:
a measuring apparatus that measures a position and a posture of the object; and
a robot that holds and moves the object,
wherein the measuring apparatus comprises:
a memory; and
a processing unit that operates on the basis of a program stored in the memory,
wherein the processing unit comprises:
a first calculation unit that processes a first image obtained by imaging the object as a first processing object; and
a second calculation unit that determines a position and a posture of the object by processing a plurality of constituent elements in the first image as a second processing object on the basis of a calculation result of the first calculation unit,
wherein the second processing object is associated with the first processing object, and
wherein the robot holds the object on the basis of the position and the posture of the object that are measured by the measuring apparatus.

17. A method of manufacturing an article comprising:
a step of measuring an object using a measuring apparatus; and
a step of manufacturing an article by processing the object on the basis of the results of the measurement,
wherein the measuring apparatus comprises:
a memory; and
a processing unit that operates on the basis of a program stored in the memory,
wherein the processing unit comprises:
a first calculation unit that processes a first image obtained by imaging the object as a first processing object; and
a second calculation unit that determines a position and a posture of the object by processing a plurality of constituent elements in the first image as a second processing object on the basis of a calculation result of the first calculation unit,
wherein the second processing object is associated with the first processing object.
